(19) United States
(12) Patent Application Publication
(10) Pub. No.: US 2026/0167828 A1
(43) Pub. Date: Jun. 18, 2026

(54) AQUEOUS SOLUTION AND METHOD FOR PRODUCING CATHODE ACTIVE MATERIAL FOR LITHIUM SECONDARY BATTERIES

(71) Applicant: SUMITOMO CHEMICAL COMPANY, LIMITED, Tokyo (JP)

(72) Inventors: Takuya KADOWAKI, Niihama-shi (JP); Yongseok CHOI, Niihama-shi (JP)

(21) Appl. No.: 19/123,557

(22) PCT Filed: Nov. 1, 2023
(86) PCT No.: PCT/JP2023/039414

§ 371 Date: Apr. 23, 2025

(30) Foreign Application Priority Data
Nov. 2, 2022 (JP) 2022-176415

(51) Int. Cl. C09D 1/00; C01G 53/44; H01M 4/485

(52) U.S. Cl. CPC C09D 1/00; C01G 53/44; H01M 4/485; C01P 2004/84; C01P 2006/40

(57) ABSTRACT

An aqueous solution contains Li, a peroxo complex of an element α, an ammonium ion, and a nitrate ion, in which the element α is one or more elements selected from the group consisting of Nb, Ti, Ta, Zr, W, Mo, and V, and in the aqueous solution, a ratio (NH₄⁺/α) of a mass molar concentration of the ammonium ion to a mass molar concentration of the element α is less than 4.5, and a mass molar concentration of the nitrate ion (NO₃⁻) is less than 4.0×10⁻³ mol/kg.

### TECHNICAL FIELD

The present invention relates to an aqueous solution and a method for producing a cathode active material for lithium secondary batteries.

Priority is claimed on Japanese Patent Application No. 2022-176415, filed on Nov. 2, 2022, the content of which is incorporated herein by reference.

### BACKGROUND ART

As the lithium secondary battery, a configuration including a cathode having a cathode active material, an anode, and an electrolyte in contact with the cathode and the anode has been known.

As the electrolyte used in the lithium secondary battery, an electrolytic solution containing an organic solvent or a solid electrolyte has been known. In the following description, the electrolytic solution and the solid electrolyte may be collectively referred to as “electrolyte”.

A cathode active material for lithium secondary batteries, which contains a coating material on a surface of particles of a lithium metal composite oxide, has been developed in both a liquid-based lithium secondary battery using an electrolytic solution and a solid-state lithium secondary battery using a solid electrolyte. In a case where the cathode active material contains a coating material, it is possible to expect suppression of an interfacial reaction due to application of a voltage while the cathode active material and the electrolyte are in direct contact with each other, and it is possible to suppress deterioration of battery performance due to a reaction product.

For example, Patent Document 1 discloses a method for producing an active material composite powder, which includes a step of spraying a coating liquid containing hydrogen peroxide, a niobium peroxo complex, and lithium as a coating substance onto an active material for lithium ion secondary batteries.

### CITATION LIST

### Patent Document

Patent Document 1: Japanese Patent No. 6034265

### SUMMARY OF INVENTION

### Technical Problem

However, in a case where the coating liquid produced by the method disclosed in Patent Document 1 is examined, the coating liquid is very unstable because, in a case where the coating liquid is allowed to stand for 24 hours after the production thereof, precipitate is generated or colloid is formed.

In a case where a coating liquid which contains a precipitate or is colloidally formed is used for forming a coating material on a surface of the cathode active material, there is a problem in that a coating amount on the surface of the cathode active material is reduced, and there is a problem in that the precipitate adheres to the surface of the cathode active material as an impurity; as a result, the resistance increases and the battery performance deteriorates.

In a case where the cathode active material is coated with such a coating liquid, a desired coating amount cannot be achieved, and an effect of suppressing the interfacial reaction during the operation of the lithium secondary battery is not sufficiently exhibited.

Furthermore, in order to use a coating liquid having poor storage stability in a process of coating a cathode active material, it is required to use the coating liquid before the precipitation or colloidization of the coating liquid occurs from the synthesis of the coating liquid, with regard to the above-described problems. Therefore, it is difficult to appropriately hold the stock of the coating liquid, and it is required to perform a producing process with poor flexibility, such as integrated control of a coating liquid synthesis process and a cathode material coating process.

The present invention has been made in view of the above circumstances, and an object of the present invention is to provide an aqueous solution which can be used as a coating liquid having excellent storage stability, and a method for producing a cathode active material for lithium secondary batteries, using the aqueous solution.

In the present specification, the term “excellent storage stability” means properties in which, after storage at normal temperature (20° C. to 25° C.) for at least 30 days after production, generation of precipitate cannot be visually confirmed and the material is not colloidal. A detailed evaluation method will be described later.

### Solution to Problem

In order to achieve the above-described object, the present invention includes the following aspects.

[1] An aqueous solution containing:
Li;
a peroxo complex of an element α;
an ammonium ion; and
a nitrate ion,
in which the element α is one or more elements selected from the group consisting of Nb, Ti, Ta, Zr, W, Mo, and V, and
in the aqueous solution, a ratio (NH₄⁺/α) of a mass molar concentration of the ammonium ion to a mass molar concentration of the element α is less than 4.5, and a mass molar concentration of the nitrate ion is less than 4.0×10⁻³ mol/kg.

[2] The aqueous solution according to [1],
in which a ratio (NO₃⁻/α) of the mass molar concentration of the nitrate ion to the mass molar concentration of the element α in the aqueous solution is less than 0.017.

[3] The aqueous solution according to [1] or [2],
in which a ratio (Li/α) of a mass molar concentration of Li to the mass molar concentration of the element α in the aqueous solution is more than 1.0.

[4] The aqueous solution according to any one of [1] to [3],
in which the mass molar concentration of the element α is 0.10 mol/kg or more.

[5] The aqueous solution according to any one of [1] to [4],
in which a pH of the aqueous solution is 11.0 or more, and the element α is Nb.

[6]A method for producing a cathode active material for lithium secondary batteries, that contains metal composite particles and a coating material with which at least part of the metal composite particles is coated, the method including:
a step X of bringing the aqueous solution according to any one of [1] to [5] into contact with the metal composite particles to coat at least part of the metal composite particles with the coating material.

[7] The method for producing a cathode active material for lithium secondary batteries according to [6],
in which the metal composite particles are a lithium metal composite oxide.

[8] The method for producing a cathode active material for lithium secondary batteries according to [6] or [7],
in which the step X includes bringing the aqueous solution into contact with the metal composite particles by spraying the aqueous solution onto the metal composite particles, drying the aqueous solution adhered to a surface of the metal composite particles, and subjecting the metal composite particles to a heat treatment.

[9]A method for producing a cathode active material for lithium secondary batteries, that uses metal composite particles and a coating material with which at least part of the metal composite particles is coated, the method including:
a step A of preparing a coating liquid,
in which the step A includes a step A1 of mixing a compound containing an element α, a solution containing hydrogen peroxide, a solution containing ammonia, and a lithium compound to prepare a solution L having a liquid temperature of higher than 40° C., and a step A2 of cooling the solution L to 40° C. or lower to obtain the coating liquid,
the element α is one or more elements selected from the group consisting of Nb, Ti, Ta, Zr, W, Mo, and V,
the coating liquid contains a peroxo complex of the element α, and Li,
a ratio (Li/α) of a mass molar concentration of Li to a mass molar concentration of the element α in the coating liquid is more than 1.0, and
an average cooling rate of the solution L from the liquid temperature to 40° C. in the step A2 is less than 0.9° C./min.

[10] The method for producing a cathode active material for lithium secondary batteries according to [9],
in which the mass molar concentration of the element α in the coating liquid is 0.10 mol/kg or more.

[11] The method for producing a cathode active material for lithium secondary batteries according to [9] or [10],
in which the step A1 includes an operation of adding the lithium compound to a slurry containing the compound containing the element α, the solution containing hydrogen peroxide, and the solution containing ammonia, the slurry having a temperature of 35° C. or higher.

[12] The method for producing a cathode active material for lithium secondary batteries according to any one of [9] to [11],
in which the step A1 includes an operation of heating a slurry containing the compound containing the element α, the solution containing hydrogen peroxide, and the solution containing ammonia at an average heating rate of 0.9° C./min or more and 10° C./min or less, and adding the lithium compound to the slurry having a temperature of 35° C. or higher.

[13] The method for producing a cathode active material for lithium secondary batteries according to any one of [9] to [12],
in which the element α is Nb.

[14] The method for producing a cathode active material for lithium secondary batteries according to any one of [9] to [13],
in which the compound containing the element α is a compound containing niobium oxide, and
the lithium compound is a compound including lithium hydroxide or lithium hydroxide hydrate.

[15] The method for producing a cathode active material for lithium secondary batteries according to any one of [9] to [14], further including, after the step A:
a step B of coating at least part of the metal composite particles with the coating liquid,
in which the step B includes spraying the coating liquid onto the metal composite particles, drying the coating liquid adhered to a surface of the metal composite particles, and subjecting the metal composite particles to a heat treatment.

### Advantageous Effects of Invention

According to the present invention, it is possible to provide an aqueous solution which can be used as a coating liquid having excellent storage stability, and a method for producing a cathode active material for lithium secondary batteries, using the aqueous solution.

Furthermore, according to the present invention, since a cathode active material for lithium secondary batteries is produced using a coating liquid having excellent storage stability, it is possible to produce a cathode active material for lithium secondary batteries, which has a desired coating material, without considering introduction of impurities derived from a precipitate of the coating liquid and without a decrease in the coating amount.

### BRIEF DESCRIPTION OF DRAWINGS

FIG. 1 A schematic view of an example of a device used for producing a coating liquid.

### DESCRIPTION OF EMBODIMENTS

In the present specification, a lithium metal composite oxide will be referred to as “LiMO”.

A cathode active material for lithium secondary batteries will be referred to as “CAM”.

A notation “Li” does not indicate an Li metal single substance, but an Li element, unless particularly otherwise specified. The same applies to notations of other elements such as Ni, Co, Mn, Nb, Ti, Ta, Zr, W, Mo, and V.

Regarding a numerical range, “A to B” means “A or more and B or less”. For example, in a case where it is described as “5 to 15 μm”, it means a range of 5 μm or more and 15 μm or less, and means a numerical range including 5 μm as a lower limit value and 15 μm as an upper limit value.

Regarding the numerical range in the present specification, the upper limit value and the lower limit value can be optionally combined.

The numerical ranges of the respective physical properties, compositions, and production conditions can be optionally combined.

### <Method 1 for Producing Cathode Active Material for Lithium Secondary Batteries>

The present embodiment is a method for producing a CAM, the CAM containing metal composite particles and a coating material with which at least part of the metal composite particles is coated.

The metal composite particles are a metal composite hydroxide, a metal composite oxide, or LiMO, and are preferably LiMO.

The production method according to the present embodiment includes a step A of preparing a coating liquid. In addition, the production method according to the present embodiment may optionally include a step B of coating at least part of the metal composite particles with the coating liquid. Hereinafter, the production method including the step A and the optional step B will be described as “production method 1”.

The coating material formed in the production method 1 has a compound containing Li and an element α.

The element α is one or more elements selected from the group consisting of Nb, Ti, Ta, Zr, W, Mo, and V; and is preferably Nb.

For example, it is preferable that the compound containing Li and the element α contains, as a main component, a lithium composite oxide containing the element α. The lithium composite oxide containing the element α is, for example, at least one or more oxides selected from the group consisting of LiNbO₃, LiTaO₃, Li₂TiO₃, Li₂WO₄, Li₄WO₅, Li₂ZrO₃, Li₂MoO₄, and LiV₃O₆. The above-described lithium composite oxide containing the element α has lithium ion conductivity.

In addition, regarding the coating material, the fact that the above-described lithium composite oxide is a “main component” means that a content of the above-described lithium composite oxide is the highest among materials for forming the coating material. The content of the above-described lithium composite oxide with respect to the entire coating material is preferably 50 mol % or more, and more preferably 60 mol % or more. In addition, the content of the above-described lithium composite oxide with respect to the entire coating material is preferably 90 mol % or less.

In the present embodiment, the coating material is preferably a coating layer or coating particles.

In the present embodiment, it is sufficient that the coating material is provided on at least part of the surface of one particle of the metal composite particles, and the entire surface of the metal composite particles may be covered with the coating material, or part of the surface of the metal composite particles may be exposed.

In the present embodiment, a formulation of the coating material can be confirmed by analyzing a cross section of the CAM by an elemental line analysis (STEM-EDX), X-ray photoelectron spectroscopy (XPS), inductively coupled plasma emission analysis (ICP), electron probe microanalyzer (EPMA), or the like.

Hereinafter, the step A and the optional step B will be described.

### [Step A]

The step A is a step of preparing a coating liquid.

The step A includes at least a step A1 and a step A2 in this order.

A solution L described later is prepared in the step A1, and in the step A2, an operation of stably maintaining the solution L is carried out to obtain a coating liquid containing a peroxo complex of the element α, and Li.

Since the peroxo complex does not contain a hydrocarbon in the chemical structure as compared with an alcohol solution of a metal alkoxide, which is known as the coating liquid, the hydrocarbon does not remain in the coating material after the coating liquid is sprayed and dried. Therefore, in a case where the peroxo complex is used, voids caused by combustion or oxidative decomposition of the hydrocarbon in the coating material during a heat treatment step described later do not occur, and thus a high-density coating material can be finally formed.

All the elements mentioned as the element α can form the peroxo complex.

In the present embodiment, examples of the peroxo complex of the element α include a niobium peroxo complex, a titanium peroxo complex, a tantalum peroxo complex, a zirconium peroxo complex, a tungsten peroxo complex, a molybdenum peroxo complex, and a vanadium peroxo complex. The peroxo complex of the element α is preferably a niobium peroxo complex.

### (Step A1)

The step A1 is a step of mixing a compound containing the element α, a solution containing hydrogen peroxide, a solution containing ammonia, and a lithium compound to prepare a solution L having a liquid temperature of higher than 40° C.

Examples of the compound containing the element α include a compound containing niobium oxide, a compound containing titanium oxide, a compound containing tantalum oxide, a compound containing zirconium oxide, a compound containing tungsten oxide, a compound containing molybdenum oxide, and a compound containing vanadium oxide; and examples thereof include niobium oxide hydrate (Nb₂O₅·nH₂O), titanium oxide hydrate (TiO₂·nH₂O), tantalum oxide hydrate (Ta₂O₅·nH₂O), zirconium oxide hydrate (ZrO₂·nH₂O), tungsten oxide hydrate (WO₃·nH₂O), molybdenum oxide hydrate (MoO₃·nH₂O), and vanadium oxide (V₂O₅). The compound containing the element α is preferably a compound containing niobium oxide.

In the present embodiment, the compound containing the element α is added at a proportion such that a mass molar concentration of the element α in the coating liquid is preferably 0.10 mol/kg or more, more preferably 0.12 mol/kg or more, and still more preferably 0.14 mol/kg or more.

The upper limit value of the molar concentration of the element α in the coating liquid is, for example, 0.50 mol/kg or less, 0.40 mol/kg or less, or 0.30 mol/kg or less.

The molar concentration of the element α in the coating liquid is, for example, 0.10 to 0.50 mol/kg, 0.12 to 0.40 mol/kg, or 0.14 to 0.30 mol/kg.

In a case where the mass molar concentration of the element α in the coating liquid is equal to or more than the above-described lower limit value, a coating material having a sufficient amount of the element α for exhibiting an effect of suppressing an interfacial reaction between a surface of the CAM and an electrolytic solution, in a case where the metal composite particles are LiMO, is easily obtained. In addition, in a case where the mass molar concentration of the element α in the coating liquid is equal to or more than the above-described lower limit value, a desired coating material can be obtained by using a small amount of the coating liquid in the step B described later, and a coating treatment time can be shortened.

In a case where the mass molar concentration of the element α of the coating liquid is equal to or less than the above-described upper limit value, the compound containing the element α is easily dissolved, and a residue is less likely to remain. In addition, in a case where the molar concentration of the element α in the coating liquid is equal to or less than the above-described upper limit value, a thin coating material having a uniform thickness is easily obtained in the step B described later.

Suitable examples of the solution containing ammonia include aqueous ammonia.

An amount of the solution containing ammonia to be added is preferably an amount such that a ratio (NH₄⁺/α) described later contained in the obtained coating liquid (aqueous solution) is in a range described later, while the ammonia reacts with the compound containing the element α and the solution containing hydrogen peroxide, and more preferably such that a pH value becomes 11.0 or more.

Suitable examples of the solution containing hydrogen peroxide include hydrogen peroxide water.

An amount of the solution containing hydrogen peroxide to be added is preferably an amount such that a mass molar concentration of the hydrogen peroxide in the obtained coating liquid (aqueous solution) is in a range described later, while the hydrogen peroxide reacts with the compound containing the element α and the solution containing ammonia.

In the step A1, the hydrogen peroxide coordinated to the element α of the compound containing the element α is converted into a peroxy group by the solution containing ammonia, and thus an intermediate in which a counter ion is NH₄⁺ is generated. The intermediate is extremely unstable, and for example, in a case where the element α is Nb, the intermediate changes to Nb₂O₅, and is likely to precipitate. However, by adding the lithium compound, the counter ion (NH₄⁺) of the intermediate is ion-exchanged with Li⁺, and thus a peroxo complex in which a counter ion is Li⁺ is obtained. The peroxo complex in which the counter ion is Li⁺ is more stable than the intermediate in which the counter ion is NH₄⁺.

Suitable examples of the lithium compound include lithium hydroxide (LiOH), lithium hydroxide hydrate (LiOH nH₂O), lithium nitrate (LiNO₃), lithium sulfate (Li₂SO₄), and lithium carbonate (Li₂CO₃).

Among these, lithium hydroxide or lithium hydroxide hydrate is preferable.

It is preferable that the lithium compound is mixed with the compound containing the element α, the solution containing hydrogen peroxide, and the solution containing ammonia at a proportion such that a ratio (Li/element α) of the obtained coating liquid, which will be described later, is in a range described later (that is, more than 1.0, preferably 1.1 or more).

The step A1 preferably includes an operation of adding the lithium compound to a slurry containing the compound containing the element α, the solution containing hydrogen peroxide, and the solution containing ammonia, the slurry having a temperature of 35° C. or higher. The temperature of the slurry in the case of adding the lithium compound is more preferably 40° C. or higher, and still more preferably 45° C. or higher.

The temperature of the slurry in the case of adding the lithium compound is, for example, 80° C. or lower, 70° C. or lower, or 65° C. or lower.

The temperature of the slurry in the case of adding the lithium compound is, for example, 35° C. to 80° C., 40° C. to 70° C., or 45° C. to 65° C.

In a case where the temperature of the slurry in the case of adding the lithium compound is equal to or higher than the above-described lower limit value, the ammonia in the slurry is likely to change to nitrous acid. In the presence of nitrous acid, the intermediate is likely to be stable, so that the storage stability is likely to be improved.

In a case where the temperature of the slurry in the case of adding the lithium compound is equal to or lower than the above-described upper limit value, the precipitate is less likely to be generated, so that the storage stability of the coating liquid is likely to be improved.

In addition, in a case where decomposition of the hydrogen peroxide proceeds rapidly and exothermicity occurs, the reaction proceeds rapidly, and thus the precipitate is likely to be generated. In a case where the temperature of the slurry in the case of adding the lithium compound is equal to or lower than the above-described upper limit value, since heat generation associated with the decomposition of the hydrogen peroxide can be suppressed, the precipitate is less likely to be generated, and thus the storage stability of the coating liquid is likely to be improved.

The temperature in the step A1 may be controlled by external heating or by heat generation during the reaction. Furthermore, the liquid temperature in the step A1 may be controlled while maintaining the temperature by pre-heating each raw material before the mixing.

The step A1 preferably includes an operation of heating the slurry at an average heating rate of 0.9 to 10° C./min and adding the lithium compound to the slurry having a temperature of 35° C. or higher. The average heating rate is preferably 1.0 to 8° C./min and more preferably 1.5 to 6° C./min.

The average heating rate is calculated by an expression of (T₁−T₀)/t₁ in which a slurry temperature at a time when the slurry is started to be mixed is defined as T₀ (° C.), a slurry temperature immediately before the lithium compound is added to the slurry is defined as T₁ (° C.), and an elapsed time of the temperature T₀ to T₁ is defined as t₁ (minutes).

By gently heating the slurry at the above-described average heating rate, the reaction can proceed under milder conditions. By causing the reaction to proceed under mild conditions, it is possible to suppress abnormal generation of the above-described intermediate, which may occur in a case of a rapid exothermic reaction, and to suppress a residual amount of the intermediate contained in the final coating liquid, thereby improving storage stability.

In a case where the temperature of the slurry in the case of adding the lithium compound in the step A1 is higher than 40° C., the heating operation may be omitted.

The above-described slurry gradually becomes a transparent solution L by controlling the procedure and the temperature conditions described above to appropriately proceed the reaction.

Next, a solution L having a liquid temperature of higher than 40° C. is prepared. The maximum temperature of the solution L obtained in the step A1 is defined as Tₘₐₓ (° C.). Tₘₐₓ is higher than 40° C., preferably 50° C. or higher, more preferably 60° C. or higher, and particularly preferably 70° C. or higher.

The upper limit of Tₘₐₓ is, for example, 90° C. or lower, 88° C. or lower, 86° C. or lower, or 84° C. or lower.

Tₘₐₓ is, for example, higher than 40° C. and 90° C. or lower, 50° C. to 88° C., 60° C. to 86° C., or 70° C. to 84° C.

In a case where Tₘₐₓ of the solution L is a temperature equal to or higher than the above-described lower limit value, the reaction between the lithium compound contained in the solution L and the above-described intermediate is accelerated, and thus it is possible to reduce unreacted components such as the ammonia and the hydrogen peroxide. As a result, it is difficult to generate a component which can form the precipitate, so that the storage stability of the coating liquid is likely to be improved.

From the viewpoint of setting the temperature of the solution L to a temperature at which the solvent of the solution L does not boil, Tₘₐₓ of the solution L is preferably equal to or lower than the above-described upper limit value.

Tₘₐₓ of the solution L may be controlled by external heating or by heat generation at the reaction temperature. For example, Tₘₐₓ may be prepared by heating the above-described slurry while mixing and stirring the slurry. Furthermore, Tₘₐₓ may be controlled by preheating the raw materials used in the step A1 before the mixing, and maintaining the temperature.

### (Step A2)

In the step A2, after the step A1, the solution L is cooled to 40° C. or lower while controlling an average cooling rate. In this manner, a coating liquid having excellent storage stability is obtained.

In the step A2, the average cooling rate is less than 0.9° C./min, preferably 0.8° C./min or less, and more preferably 0.7° C./min or less.

The lower limit value of the average cooling rate is, for example, 0.1° C./min or more, 0.2° C./min or more, or 0.3° C./min or more.

The average cooling rate in the step A2 is, for example, 0.1° C./min or more and less than 0.9° C./min, 0.2 to 0.8° C./min, or 0.3 to 0.7° C./min.

By gently cooling the reaction solution such that the average cooling rate in the step A2 is equal to or less than the above-described upper limit value, a structure of the obtained peroxo complex is likely to be maintained. As a result, components which can be precipitated in the coating liquid, for example, an oxide of the element α are less likely to be generated, and thus the storage stability is likely to be improved. From the viewpoint of improving production efficiency, the average cooling rate in the step A2 is preferably set to be equal to or more than the above-described lower limit value.

The average cooling rate is calculated by an expression of (Tₘₐₓ−40)/t₂ in a case where the temperature is lowered from Tₘₐₓ (° C.) to 40° C. in an elapsed time t₂ (minutes).

In this manner, the coating liquid is obtained. A ratio (Li/α) of a mass molar concentration of Li to a mass molar concentration of the element α, which are contained in the coating liquid, is more than 1.0, preferably 1.1 or more. The upper limit value of the ratio (Li/α) is, for example, 1.6 or less, 1.5 or less, or 1.4 or less.

The ratio (Li/α) is, for example, more than 1.0 and 1.6 or less, 1.1 to 1.5, or 1.1 to 1.4. Among these, 1.1 to 1.4 is particularly preferable.

The ratio (Li/α) can be measured by a method described in [Quantitative analysis method for Li and element α] later.

In a case where the ratio (Li/α) of the coating liquid is equal to or more than the above-described lower limit value, the amount of the lithium ion (Li⁺) coordinated to the peroxo complex of the element α contained in the coating liquid is in a satisfactory state. In this state, the lithium ion (Li⁺) is coordinated to the peroxo complex of the element α without being insufficiently coordinated, and thus the peroxo complex is stabilized. The above-described intermediate which is more unstable is hardly generated. In addition, since the peroxo complex in which the counter ion is Li⁺ is stable and difficult to decompose, the generation of precipitate can be suppressed. As a result, the storage stability of the coating liquid is improved.

In a case where the ratio (Li/α) of the coating liquid is equal to or less than the above-described upper limit value, Li contained in the obtained coating material is an appropriate amount that is unlikely to be in an excessive amount. In a case where the excessive Li is contained in the coating material, formation of a resistance layer such as lithium carbonate on the surface of the metal composite particles may cause a decrease in battery performance. In the present embodiment, since the coating material containing an appropriate amount of Li can be formed, such a decrease in battery performance is unlikely to occur.

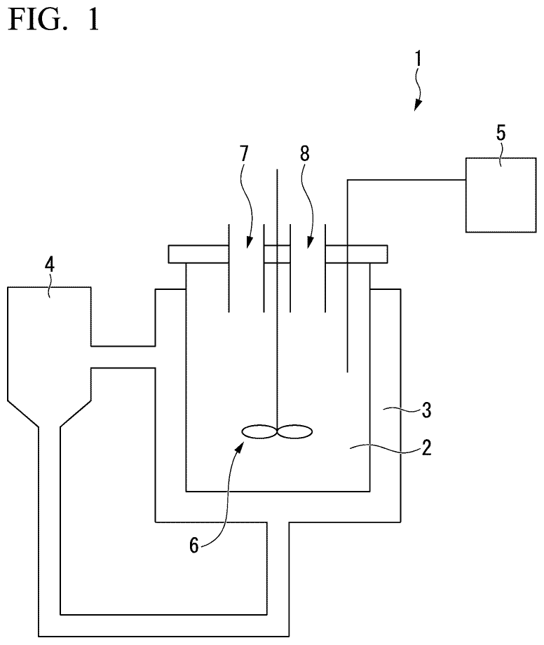

FIG. 1 shows an example of a schematic view of a device used for performing the step A1 and the step A2.

A device 1 shown in FIG. 1 includes a reaction tank 2, a temperature adjusting unit 3, a temperature control part 4, a thermometer 5, a stirring blade 6, a raw material inlet 7, and a gas discharge outlet 8.

Each raw material is charged from the raw material inlet 7 of the reaction tank 2, and the reaction tank 2 is cooled or heated by the temperature adjusting unit 3 such that the liquid temperature reaches a target temperature. The temperature adjusting unit 3 is connected to the temperature adjusting part 4, and for example, the reaction tank 2 can be cooled by allowing cooling water cooled by the temperature adjusting part 4 to pass through the temperature adjusting unit 3. The reaction tank 2 may be heated by allowing a heat medium heated by the temperature adjusting part 4 to pass through the temperature adjusting unit 3.

### [Step B]

The step B is a step of coating at least part of the metal composite particles with the coating liquid obtained in the step A. In this case, a coating liquid immediately after cooling may be used, or a coating liquid further cooled may be used.

The metal composite particles are, for example, a compound containing any one or more elements of Ni, Co, Mn, Al, W, B, Mo, Zn, Sn, Zr, Ga, La, Ti, Nb, and V.

Examples of the metal composite particles include a metal composite hydroxide or a metal composite oxide containing the above-described element, and LiMO containing the above-described element and Li.

The metal composite hydroxide is, for example, a nickel-cobalt-manganese composite hydroxide or a nickel-cobalt-aluminum composite hydroxide; and the metal composite oxide is, for example, a nickel-cobalt-manganese composite oxide or a nickel-cobalt-aluminum composite oxide.

In addition, the metal composite particles are preferably LiMO; and LiMO is preferably a compound containing Li, Ni, and one or more elements selected from the group consisting of Co, Mn, and Al, and more preferably a lithium-nickel-cobalt-manganese composite metal compound or a lithium-nickel-cobalt-aluminum composite metal compound.

The metal composite hydroxide can be produced according to a continuous coprecipitation method described in JP-A-2002-201028. The metal composite oxide can be produced by oxidizing a metal composite hydroxide by an oxidative heat treatment or the like. LiMO can be produced by mixing the metal composite hydroxide or the metal composite oxide with a lithium compound and sintering the mixture.

The step B is preferably a step of spraying the coating liquid onto the metal composite particles.

The coating liquid is sprayed onto the metal composite particles to adhere the coating liquid to a surface of the metal composite particles. Furthermore, in the step B, it is preferable to dry the coating liquid in order to remove volatile components such as a solvent and hydrated water, which are contained in the coating liquid.

The step B can be performed using a roll-to-roll flow coating device, a spray dryer, or the like.

In the step B, a roll-to-roll flow coating device is suitably used in which a high-temperature gas is supplied while allowing the metal composite particles to flow in the tank, the coating liquid is sprayed using a spray, and the coating liquid is brought into contact with the metal composite particles.

As the roll-to-roll flow coating device, for example, MP-01 manufactured by Powrex corp. can be used.

The step B includes a heat treatment step after spraying the coating liquid onto the metal composite particles and drying the coating liquid.

Heat treatment conditions may vary depending on the type of raw materials contained in the coating liquid. As the heat treatment conditions, the type of atmosphere gas, the heat treatment temperature, the holding time of the heat treatment are exemplary examples.

For example, in a case where a material containing Nb as the element α is used, it is preferable to carry out the heat treatment in an atmosphere containing an oxidizing gas such as air and oxygen in a temperature range of 200° C. to 500° C. for 1 to 10 hours.

The heat treatment temperature in the present specification means a temperature of an atmosphere in a heating furnace, and is the highest temperature of the holding temperature in the heat treatment step. In a case where the heat treatment step includes a plurality of heating steps, the heat treatment temperature means the highest temperature in a heating step at the highest temperature.

By subjecting the metal composite particles after drying the adhered coating liquid to the heat treatment under the above-described heat treatment conditions, moisture and flammable components of the coating material on the surface of the metal composite particles are removed to oxidize the coating material, and the coating material can be formed on the surface of the metal composite particles.

The CAM can be produced through the step A and the optional step B.

The CAM may be used after being appropriately crushed and classified.

### <Aqueous Solution>

The aqueous solution according to the present embodiment contains Li, a peroxo complex of the element α, an ammonium ion, and a nitrate ion. It is preferable that the aqueous solution further contains hydrogen peroxide.

The aqueous solution according to the present embodiment is the coating liquid described in the production method 1 above.

In the aqueous solution which is the coating liquid described in the production method 1, a ratio (NH₄⁺/t) of a mass molar concentration of the ammonium ion to a mass molar concentration of the element α is less than 4.5, and a mass molar concentration of the nitrate ion is less than 4.0×10⁻³ mol/kg.

The formulation and the like of the aqueous solution can be confirmed by the following method.

### [Method of Specifying Content of Peroxo Complex]

10 g of the aqueous solution as a sample is added to 100 ml of isopropanol, the obtained precipitate is measured by a Fourier transform infrared absorption spectrum (FT-IR) measuring device, and the presence or absence of a peak derived from a bond between oxygen elements (0-0 bond) is confirmed. The peak derived from the O—O bond is, for example, a peak in a frequency range of 850 to 900 cm-1.

For the FT-IR measuring device, for example, NICOLET 6700 manufactured by Thermo Scientific Inc. can be used.

[Quantitative analysis method for Li and element α]

0.1 g of the aqueous solution as a sample is weighed in a container, hydrofluoric acid and nitric acid are added thereto to be made into a constant volume, and analysis can be carried out using an inductively coupled plasma emission (ICP) analysis device.

As the ICP analysis device, for example, 5110 manufactured by Agilent Technologies, Inc. and analysis software ICP Expert can be used.

[Quantitative analysis method for hydrogen peroxide (H₂O₂)]

0.1 g of the aqueous solution as a sample is diluted with pure water and separated into a container. 1 mL of an Ti-PAR test solution and 3 mL of a pH buffer solution are added to the container, and the total amount is adjusted to 10 mL with pure water to obtain a measurement solution.

The above-described Ti-PAR test solution is a solution obtained by mixing an Ti solution of 3.0×10⁻³ mol/L and a PAR (4-(2-pyridylazo)resorcinol) solution of 3.0×10⁻³ mol/L at a volume ratio of 4:3.

The above-described pH buffer solution is an ammonia buffer solution (1.5 mol/L, pH: 8.6).

After allowing the measurement solution to stand for 10 minutes, an absorbance at a wavelength of 508 nm is measured using a spectrophotometer, and the mass molar concentration of hydrogen peroxide contained in the aqueous solution as a sample is determined from a calibration curve created using a standard sample.

As the spectrophotometer, for example, V-650 manufactured by JASCO Corporation and a spectrum manager of analysis software can be used.

[Quantitative analysis method for ammonium ion (NH₄⁺)]

0.1 g of the aqueous solution as a sample is weighed in a container, the aqueous solution is diluted with a 10 mM methanesulfonic acid solution, the supernatant is filtered, and the measurement is carried out by ion chromatography. In this manner, the mass molar concentration of NH₄⁺ in the aqueous solution can be measured.

For the ion chromatography, for example, ICS-1000 manufactured by Nippon Dionex K.K. and analysis software Chromereon can be used.

[Quantitative analysis method for nitrate ion (NO₃⁻)]

0.1 g of the aqueous solution is diluted with pure water, and the measurement is carried out by ion chromatography, whereby the mass molar concentration of NO₃⁻ in the aqueous solution can be measured.

For the ion chromatography, for example, ICS-1000 manufactured by Nippon Dionex K.K. and analysis software Chromereon can be used.

[Measurement method for pH]

A pH of the aqueous solution can be measured by the following method.

The aqueous solution as a sample is put in a container, and the container is put in a polybag with a chuck.

The pH is measured with a pH meter while blowing nitrogen gas into the polybag with a chuck.

For example, SANZIP manufactured by C.I. TAKIRON Corporation can be used as the polybag with a chuck. As the pH meter, for example, F-52 manufactured by Horiba, Ltd. can be used.

In the aqueous solution according to the present embodiment, the ratio (NH₄⁺/t) of the mass molar concentration of the ammonium ion (NH₄⁺) measured by the method described in the section of [Quantitative analysis method for ammonium ion (NH₄⁺)] to the mass molar concentration of the element α measured by the method described in the section of [Quantitative analysis method for Li and element α] is less than 4.5, preferably 4.3 or less and more preferably 4.1 or less. In addition, the ratio (NH₄⁺/t) is, for example, 1.0 or more, 2.0 or more, or 3.0 or more.

The ratio (NH₄⁺/t) is, for example, 1.0 or more and less than 4.5, 2.0 to 4.3, or 3.0 to 4.1.

In a case where the ratio (NH₄⁺/α) is less than the above-described upper limit value, the amount of unreacted ammonia component with respect to the peroxo complex of the element α contained in the aqueous solution is small, and it is difficult to generate a component which can form the precipitate, which is preferable.

In a case where the ratio (NH₄⁺/α) is equal to or more than the above-described lower limit value, the ammonium ion (NH₄⁺) can be coordinated at a portion where Li⁺ is insufficient with respect to the peroxo complex of the element α contained in the aqueous solution, which is preferable from the viewpoint of obtaining a solution having excellent storage stability.

In the aqueous solution according to the present embodiment, the mass molar concentration of the nitrate ion measured by the method described in the section of [Quantitative analysis method for nitrate ion (NO₃⁻)] is less than 4.0×10⁻³ mol/kg, preferably 3.5×10⁻³ mol/kg or less and more preferably 3.0×10⁻³ mol/kg or less. In addition, the mass molar concentration of the nitrate ion is, for example, 1.0×10⁻³ mol/kg or more, 2.0×10⁻³ mol/kg or more, and 2.5×10⁻³ mol/kg or more.

The mass molar concentration of the nitrate ion is, for example, 1.0×10⁻³ mol/kg or more and less than 4.0×10⁻³ mol/kg, 2.0 to 3.5×10⁻³ mol/kg, or 2.5 to 3.0×10⁻³ mol/kg.

In a case where the mass molar concentration of the nitrate ion is less than the above-described upper limit value, the aqueous solution is likely to maintain alkalinity in which the peroxo complex of the element α is stably present, the precipitation of the aqueous solution is unlikely to be generated, and thus the storage stability is likely to be improved.

In a case where the mass molar concentration of the nitrate ion is equal to or more than the above-described lower limit value, a post-treatment step of removing the nitrate ion is not required, and it is easy to efficiently produce the aqueous solution. The nitrate ion is generated by oxidizing ammonia contained in the raw material with hydrogen peroxide, and in a case where the nitrate ion is less than the above-described lower limit value, the post-treatment step of removing the nitrate ion may be required.

In the aqueous solution according to the present embodiment, the ratio (NO₃⁻/α) of the mass molar concentration of the nitrate ion measured by the method described in the section of [Quantitative analysis method for nitrate ion (NO₃⁻)] to the mass molar concentration of the element α measured by the method described in the section of [Quantitative analysis method for Li and element α] is less than 0.017, preferably 0.015 or less and more preferably 0.013 or less. The ratio (NO₃⁻/α) is, for example, 0.010 or more, 0.011 or more, or 0.012 or more.

The ratio (NO₃⁻/α) is, for example, 0.010 or more and less than 0.017, 0.011 to 0.015, or 0.012 to 0.013.

In a case where the ratio (NO₃⁻/α) is less than the above-described upper limit value, the amount of the nitrate ion with respect to the peroxo complex of the element α contained in the aqueous solution is small, an alkaline region in which the peroxo complex of the element α is more stably present is easily maintained, the precipitate of the aqueous solution is hardly generated, and the storage stability is easily improved.

In a case where the ratio (NO₃⁻/α) is equal to or more than the above-described lower limit value, the nitrate ion is appropriately present in the aqueous solution containing the peroxo complex of the element α, and thus the aqueous solution can be efficiently produced because the post-treatment step of removing the nitrate ion is not required.

In the aqueous solution according to the present embodiment, the mass molar concentration of the hydrogen peroxide quantified by the section of [Quantitative analysis method for hydrogen peroxide (H₂O₂)] is less than 50 mmol/kg, preferably 48 mmol/kg or less and more preferably 47 mmol/kg or less. In addition, the mass molar concentration of the hydrogen peroxide is, for example, 10 mol/kg or more, 20 mol/kg or more, or 40 mol/kg or more.

The mass molar concentration of the hydrogen peroxide is, for example, 10 mol/kg or more and less than 50 mol/kg, 20 to 48 mol/kg, or 40 to 47 mol/kg.

In a case where the mass molar concentration of the hydrogen peroxide is less than the above-described upper limit value, the amount of unreacted hydrogen peroxide which is one of the raw materials during the synthesis is small, and the generation of precipitate after the synthesis of the aqueous solution can be suppressed, so that the storage stability is likely to be improved.

In a case where the mass molar concentration of the hydrogen peroxide is equal to or more than the above-described lower limit value, a post-treatment step of removing the hydrogen peroxide is not required, and thus it is easy to efficiently produce the aqueous solution.

In the aqueous solution according to the present embodiment, the mass molar concentration of the element α measured by the method described in the section of [Quantitative analysis method for Li and element α] is preferably 0.10 mol/kg or more, more preferably 0.12 mol/kg or more, and still more preferably 0.14 mol/kg or more. The mass molar concentration of the element α is, for example, 0.50 mol/kg or less, 0.40 mol/kg or less, or 0.30 mol/kg or less. The mass molar concentration of the element α is, for example, 0.10 to 0.50 mol/kg, 0.12 to 0.40 mol/kg, or 0.14 to 0.30 mol/kg.

In a case where the mass molar concentration of the element α is equal to or less than the above-described upper limit value, a compound containing the element α is easily dissolved during the synthesis of the aqueous solution, and a residue is unlikely to remain. In addition, in the step B described later, a thin coating material having a uniform thickness is easily obtained.

In a case where the mass molar concentration of the element α is equal to or more than the above-described lower limit value, in the step of forming the coating material on the surface of the metal composite particles with the aqueous solution as a coating liquid, a desired coating material can be obtained using a small amount of the coating liquid, and the coating treatment time can be shortened.

The pH of the aqueous solution according to the present embodiment, measured by the section of [Measurement method for pH], is preferably 11.0 or more, more preferably 11.1 or more, and still more preferably 11.2 or more. The pH of the aqueous solution is, for example, 13.0 or less, 12.5 or less, or 12.0 or less.

The pH of the aqueous solution is, for example, 11.0 to 13.0, 11.1 to 12.5, or 11.2 to 12.0.

In a case where the pH of the aqueous solution is equal to or more than the above-described lower limit value, the aqueous solution is alkaline, and the peroxo complex of the element α is likely to be stable.

In a case where the pH of the aqueous solution is equal to or less than the above-described upper limit value, excessive ammonia is not present, and for example, an ammonium niobium complex is not easily generated. Therefore, the aqueous solution is less likely to be colloidal, and the storage stability is likely to be improved.

In the aqueous solution according to the present embodiment, the ratio (Li/α) of the mass molar concentration of Li to the mass molar concentration of the element α, which are measured by the method described in the section of [Quantitative analysis method for Li and element α], is more than 1.0, preferably 1.1. The ratio (Li/α) of the aqueous solution is, for example, 1.6 or less, 1.5 or less, or 1.4 or less.

The ratio (Li/α) of the aqueous solution is, for example, more than 1.0 and 1.6 or less, 1.1 to 1.5, or 1.1 to 1.4.

In a case where the ratio (Li/α) of the aqueous solution is equal to or more than the above-described lower limit value, the amount of the lithium ion (Li⁺) coordinated to the peroxo complex of the element α contained in the aqueous solution is in a satisfactory state. In this state, the lithium ion (Li⁺) is coordinated to the peroxo complex of the element α without being insufficiently coordinated, and thus the peroxo complex is stabilized. In addition, the above-described intermediate which is more unstable is hardly generated. In addition, the peroxo complex in which the counter ion is Li⁺ is stable and difficult to decompose, so that the generation of precipitate can be suppressed. As a result, the storage stability of the aqueous solution is likely to be improved.

In a case where the ratio (Li/α) of the aqueous solution is equal to or less than the above-described upper limit value, Li contained in the coating material which is obtained by using the aqueous solution as a coating liquid is an appropriate amount that is unlikely to be in an excessive amount. In a case where the excessive Li is contained in the coating material, formation of a resistance layer such as lithium carbonate on the surface of the metal composite particles may cause a decrease in battery performance. In the present embodiment, since the coating material containing an appropriate amount of Li can be formed, such a decrease in battery performance is unlikely to occur.

The aqueous solution according to the present embodiment contains the peroxo complex of the element α. The peroxo complex of the element α can include the same complex as the peroxo complex described in the production method 1 above.

In a case where the aqueous solution has the above-described formulation, the amount of unreacted components due to an unstable intermediate are small, and the precipitation is less likely to occur, so that the storage stability is likely to be improved. In addition, it is considered that a large amount of stable peroxo complexes is maintained.

The aqueous solution according to the present embodiment preferably contains Nb as the element α, and more preferably contains a niobium peroxo complex.

### <Method 2 for Producing Cathode Active Material for Lithium Secondary Batteries>

The present embodiment is a method for producing a CAM containing metal composite particles and a coating material with which at least part of the metal composite particles is coated.

The production method according to the present embodiment includes a step X of bringing the above-described aqueous solution according to the present embodiment into contact with the metal composite particles to coat at least part of the metal composite particles with the coating material. The production method including the step X will be described as “production method 2”.

The metal composite particles used in the production method 2 are the same as the metal composite particles described in the production method 1 above.

In the step X, the above-described aqueous solution according to the embodiment of the present invention is brought into contact with the metal composite particles to coat at least part of the metal composite particles. It is preferable that the step X includes bringing the aqueous solution into contact with the metal composite particles by spraying the above-described aqueous solution onto the above-described metal composite particles, drying the aqueous solution adhered to a surface of the metal composite particles, and subjecting the metal composite particles to a heat treatment.

The device, the heat treatment conditions, and the like for performing the step X are the same as the conditions described in the step B.

### <Liquid-Type Lithium Secondary Battery>

The CAM produced according to the present embodiment can be suitably used as a cathode active material for liquid lithium secondary batteries, which is used in contact with an electrolytic solution.

An example of the liquid-type lithium secondary battery has a cathode, an anode, a separator interposed between the cathode and the anode, and an electrolytic solution disposed between the cathode and the anode.

### <Solid Lithium Secondary Battery>

The CAM produced according to the present embodiment can be suitably used as a cathode active material for solid lithium secondary batteries, which is used in contact with a solid electrolyte.

An example of the solid lithium secondary battery includes a laminate having a cathode electrode, an anode electrode, and a solid electrolyte layer.

Examples of the cathode electrode, the anode electrode, the separator, the electrolytic solution, and the solid electrolyte layer used in the liquid lithium secondary battery or the solid lithium secondary battery include materials described in WO2022/113904A1.

### EXAMPLES

Hereinafter, the present invention will be described with reference to Examples, but the present invention is not limited thereto.

### <Evaluation Method of Storage Stability>

Storage stability of an aqueous solution (coating liquid) obtained by a method described later was evaluated by the following method. For three points in time of immediately after the production, after 24 hours from the production, and after 30 days from the production, 500 ml of more of the aqueous solution was placed in a polypropylene container (Good Boy 1000 mL manufactured by AS ONE Corporation, body diameter: 096 mm), and the container was covered and then shaken and stirred 10 times or more at an amplitude of 10 cm or more for 10 seconds.

Thereafter, the container was allowed to stand on a horizontal place at an atmosphere temperature of 20° C. to 25° C., the container was irradiated with a laser pointer (wavelength: 532 nm, output: 1 mW) from an outer side surface of the container at a position of approximately half of the liquid level height (a range of ±1 cm from a height of half of the liquid level height was allowed as an error range), and the laser light passed through the polypropylene container and the aqueous solution was confirmed on white paper provided at a position 3 cm away from the facing point of irradiation.

In this case, the contour of the laser light could be confirmed on the white paper, and the contour was defined as “transparent” in a case where the contour was within a range of a diameter of 05 mm, and it was evaluated that the storage stability was excellent in a case where the laser light was “transparent” at all of three points in time of immediately after the production, after 24 hours after the production, and after 30 days after the production.

The product was stored for 24 hours after the production and for 30 days after the production, in a place where direct sunlight was not applied and the temperature was controlled to 20° C. to 25° C.

In a case where the contour of the laser light on the white paper was not confirmed or the contour was larger than 05 mm in the above-described method, it was determined that the laser light was scattered by fine particles generated inside the solution, which were formed by precipitation or colloidization, and it was evaluated as “poor storage stability”.

### <Analysis of Aqueous Solution>

With regard to the coating liquid or the aqueous solution produced by the method described later, the ratio (NH₄⁺/α), the value of the mass molar concentration of the nitrate ion (NO₃⁻ concentration in Table 1), the ratio (NO₃⁻/α), the value of the mass molar concentration of the element α (α concentration in Table 1), the ratio (Li/α), the pH, and the mass molar concentration of the hydrogen peroxide were measured according to the methods described in the section of [Quantitative analysis method for Li and element α], [Quantitative analysis method for hydrogen peroxide (H₂O₂)], [Quantitative analysis method for ammonium ion (NH₄⁺)], [Quantitative analysis method for nitrate ion (NO₃⁻)], and [Measurement method for pH] above.

### <Calculation of Average Heating Rate>

An average heating rate was calculated by an expression of (T₁−T₀)/t₁ in which a slurry temperature at a time when a slurry was started to be mixed is defined as T₀ (° C.), a slurry temperature immediately before a lithium compound was added to the slurry is defined as T₁ (° C.), and a time of T₀ to T₁ is defined as t₁ (minutes).

### <Calculation of Average Cooling Rate>

The average cooling rate was calculated by an expression of (Tₘₐₓ−40)/t₂ in a case where the temperature was lowered from the maximum temperature Tₘₐₓ (° C.) to 40° C. in a time to (minutes).

### Example 1

### [Step A]

The following device was used in order to perform the step A.

A cooling water jacket and a tubular separable flask (content volume: 2 L) provided with a discharge cock below were fixed to a frame. A four-port separable cover fitted to the above-described separable flask was attached. A stirring blade directly connected to a motor and a thermocouple capable of monitoring temperature were attached using two separable cover openings.

The remaining two openings were used as a gas discharge outlet and a raw material inlet.

The discharge port was provided with a sufficient opening area so that the pressure in the flask did not rise significantly during liquid synthesis.

A line through which cooling water subjected to temperature control (cooling or heating) could flow was attached to the cooling water jacket.

### (Step A1)

From the raw material inlet of the device having the above-described configuration, 414.00 g of pure water and 364.60 g of hydrogen peroxide water (manufactured by FUJIFILM Wako Pure Chemical Corporation, concentration: 30% by mass) were charged, and 27.76 g of niobium oxide hydrate (Nb₂O₅·nH₂O, manufactured by Mitsuwa Chemical Co., Ltd.; content of Nb₂O₅ was 79%) was further added thereto. After the addition of the niobium oxide hydrate, the temperature was adjusted to 20° C. while sufficiently stirring. In this manner, a slurry 1 was obtained.

55.50 g of aqueous ammonia (manufactured by FUJIFILM Wako Pure Chemical Corporation, concentration: 28% by mass) was added to the obtained slurry 1 at 20° C., and the mixture was sufficiently stirred.

Thereafter, the slurry 1 was heated to 60° C. at an average heating rate of 3.1° C./min.

7.94 g of lithium hydroxide monohydrate (manufactured by FUJIFILM Wako Pure Chemical Corporation) was added to the slurry 1 having a temperature of 60° C., the temperature was raised to 79° C. while sufficiently stirring, and a solution L-1 having a liquid temperature of 79° C. was obtained.

### (Step A2)

Thereafter, the liquid temperature of the solution L-1 was lowered from 79° C. to 40° C. at an average cooling rate of 0.5° C./min, thereby obtaining a coating liquid 1. A mass molar concentration of Nb in the obtained coating liquid 1 was 0.22 mol/kg, and as a result of measurement by the method described in [Method of specifying content of peroxo complex] above, a peroxo complex of Nb was contained.

In the coating liquid 1, a ratio (NH₄⁺/α) was 4.1, a mass molar concentration of the nitrate ion (NO₃⁻) was 2.8×10⁻³ mol/kg, a ratio (NO₃⁻/α) was 0.013, a pH was 11.2, a ratio (Li/α) was 1.1, a mass molar concentration of a was 0.22 mol/kg, and a mass molar concentration of hydrogen peroxide was 44 mol/kg.

The NH₄⁺/α, the mass molar concentration of the nitrate ion (NO₃⁻ concentration), the mass molar concentration of a (a concentration), the NO₃⁻/α, the pH, and the Li/a are shown in Table 1. Table 1 also shows the results of Examples and Comparative Examples.

In a case where the coating liquid 1 was evaluated according to <Evaluation method of storage stability> described above, it was confirmed that the coating liquid was transparent at three points in time of immediately after the production, after 24 hours after the production, and after 30 days after the production, and had excellent storage stability.

### Example 2

### [Step A]

The same device as in Example 1 above was used.

### (Step A1)

From the raw material inlet of the device having the above-described configuration, 413.80 g of pure water and 364.50 g of hydrogen peroxide water (manufactured by FUJIFILM Wako Pure Chemical Corporation, concentration: 30% by mass) were charged, and 27.78 g of niobium oxide hydrate (Nb₂O₅·nH₂O, manufactured by Mitsuwa Chemical Co., Ltd.; content of Nb₂O₅ was 79%) was further added thereto. After the addition of the niobium oxide hydrate, the temperature was adjusted to 20° C. while sufficiently stirring. In this manner, a slurry 2 was obtained.

55.20 g of aqueous ammonia (manufactured by FUJIFILM Wako Pure Chemical Corporation, concentration: 28% by mass) was added to the obtained slurry 2 at 20° C., and the mixture was sufficiently stirred.

Thereafter, the slurry 2 was heated to 60° C. at an average heating rate of 3.6° C./min.

7.94 g of lithium hydroxide monohydrate (manufactured by FUJIFILM Wako Pure Chemical Corporation) was added to the slurry 2 at 60° C., the temperature was raised to 80° C. while sufficiently stirring, and a solution L-2 having a liquid temperature of 80° C. was obtained.

### (Step A2)

The liquid temperature of the solution L-2 was lowered from 80° C. to 40° C. at an average cooling rate of 0.7° C./min, thereby obtaining a coating liquid 2. A mass molar concentration of hydrogen peroxide in the obtained coating liquid 2 was 44 mol/kg.

In a case where the coating liquid 2 was evaluated according to <Evaluation method of storage stability> described above, it was confirmed that the coating liquid was transparent at three points in time of immediately after the production, after 24 hours after the production, and after 30 days after the production, and had excellent storage stability.

### Example 3

### [Step A]

The same device as in Example 1 above was used.

### (Step A1)

From the raw material inlet of the device having the above-described configuration, 414.00 g of pure water and 364.78 g of hydrogen peroxide water (manufactured by FUJIFILM Wako Pure Chemical Corporation, concentration: 30% by mass) were charged, and 27.77 g of niobium oxide hydrate (Nb₂O₅·nH₂O, manufactured by Mitsuwa Chemical Co., Ltd.; content of Nb₂O₅ was 79%) was further added thereto. After the addition of the niobium oxide hydrate, the temperature was adjusted to 16° C. while sufficiently stirring. In this manner, a slurry 3 was obtained.

55.20 g of aqueous ammonia (manufactured by FUJIFILM Wako Pure Chemical Corporation, concentration: 28% by mass) was added to the obtained slurry 3 at 16° C., and the mixture was sufficiently stirred.

Thereafter, the slurry 3 was heated to 55° C. at an average heating rate of 2.3° C./min.

7.94 g of lithium hydroxide monohydrate (manufactured by FUJIFILM Wako Pure Chemical Corporation) was added to the slurry 3 having a temperature of 55° C., the temperature was raised to 75° C. while sufficiently stirring, and a solution L-3 having a liquid temperature of 75° C. was obtained.

### (Step A2)

The liquid temperature of the solution L-3 was lowered from 75° C. to 40° C. at an average cooling rate of 0.5° C./min, thereby obtaining a coating liquid 3. A mass molar concentration of hydrogen peroxide in the obtained coating liquid 3 was 41 mol/kg.

In a case where the coating liquid 3 was evaluated according to <Evaluation method of storage stability> described above, it was confirmed that the coating liquid was transparent at three points in time of immediately after the production, after 24 hours after the production, and after 30 days after the production, and had excellent storage stability.

### Example 4

### [Step A]

The same device as in Example 1 above was used.

### (Step A1)

From the raw material inlet of the device having the above-described configuration, 413.79 g of pure water and 364.77 g of hydrogen peroxide water (manufactured by FUJIFILM Wako Pure Chemical Corporation, concentration: 30% by mass) were charged, and 27.75 g of niobium oxide hydrate (Nb₂O₅·nH₂O, manufactured by Mitsuwa Chemical Co., Ltd.; content of Nb₂O₅ was 79%) was further added thereto. After the addition of the niobium oxide hydrate, the temperature was adjusted to 24° C. while sufficiently stirring. In this manner, a slurry 4 was obtained.

55.27 g of aqueous ammonia (manufactured by FUJIFILM Wako Pure Chemical Corporation, concentration: 28% by mass) was added to the obtained slurry 4 at 24° C., and the mixture was sufficiently stirred.

Thereafter, the slurry 4 was heated to 45° C. at an average heating rate of 3.1° C./min.

7.94 g of lithium hydroxide monohydrate (manufactured by FUJIFILM Wako Pure Chemical Corporation) was added to the slurry 4 having a temperature of 45° C., the temperature was raised to 75° C. while sufficiently stirring, and a solution L-4 having a liquid temperature of 75° C. was obtained.

### (Step A2)

The liquid temperature of the solution L-4 was lowered from 75° C. to 40° C. at an average cooling rate of 0.7° C./min, thereby obtaining a coating liquid 4. A mass molar concentration of hydrogen peroxide in the obtained coating liquid 4 was 41 mol/kg.

In a case where the coating liquid 4 was evaluated according to <Evaluation method of storage stability> described above, it was confirmed that the coating liquid was transparent at three points in time of immediately after the production, after 24 hours after the production, and after 30 days after the production, and had excellent storage stability.

### Example 5

### [Step A]

The same device as in Example 1 above was used.

### (Step A1)

From the raw material inlet of the device having the above-described configuration, 413.82 g of pure water and 364.72 g of hydrogen peroxide water (manufactured by FUJIFILM Wako Pure Chemical Corporation, concentration: 30% by mass) were charged, and 27.76 g of niobium oxide hydrate (Nb₂O₅·nH₂O, manufactured by Mitsuwa Chemical Co., Ltd.; content of Nb₂O₅ was 79%) was further added thereto. After the addition of the niobium oxide hydrate, the temperature was adjusted to 21° C. while sufficiently stirring. In this manner, a slurry 5 was obtained.

55.28 g of aqueous ammonia (manufactured by FUJIFILM Wako Pure Chemical Corporation, concentration: 28% by mass) was added to the obtained slurry 5 at 21° C., and the mixture was sufficiently stirred.

Thereafter, the slurry 5 was heated to 35° C. at an average heating rate of 5.3° C./min. 7.94 g of lithium hydroxide monohydrate (manufactured by FUJIFILM Wako Pure Chemical Corporation) was added to the slurry 5 having a temperature of 35° C., the temperature was raised to 73° C. while sufficiently stirring, and a solution L-5 having a liquid temperature of 73° C. was obtained.

### (Step A2)

The liquid temperature of the solution L-5 was lowered from 73° C. to 40° C. at an average cooling rate of 0.8° C./min, thereby obtaining a coating liquid 5. A mass molar concentration of hydrogen peroxide in the obtained coating liquid 5 was 47 mol/kg.

In a case where the coating liquid 5 was evaluated according to <Evaluation method of storage stability> described above, it was confirmed that the coating liquid was transparent at three points in time of immediately after the production, after 24 hours after the production, and after 30 days after the production, and had excellent storage stability.

### Example 6

### [Step A]

The same device as in Example 1 above was used.

### (Step A1)

From the raw material inlet of the device having the above-described configuration, 413.80 g of pure water and 364.78 g of hydrogen peroxide water (manufactured by FUJIFILM Wako Pure Chemical Corporation, concentration: 30% by mass) were charged, and 18.50 g of niobium oxide hydrate (Nb₂O₅·nH₂O, manufactured by Mitsuwa Chemical Co., Ltd.; content of Nb₂O₅ was 79%) was further added thereto. After the addition of the niobium oxide hydrate, the temperature was adjusted to 23° C. while sufficiently stirring. In this manner, a slurry 6 was obtained.

36.85 g of aqueous ammonia (manufactured by FUJIFILM Wako Pure Chemical Corporation, concentration: 28% by mass) was added to the obtained slurry 6 at 23° C., and the mixture was sufficiently stirred.

Thereafter, the slurry 6 was heated to 55° C. at an average heating rate of 1.4° C./min. 5.29 g of lithium hydroxide monohydrate (manufactured by FUJIFILM Wako Pure Chemical Corporation) was added to the slurry 6 having a temperature of 55° C., the temperature was raised to 58° C. while sufficiently stirring, and a solution L-6 having a liquid temperature of 58° C. was obtained.

### (Step A2)

The liquid temperature of the solution L-6 was lowered from 58° C. to 40° C. at an average cooling rate of 0.5° C./min, thereby obtaining a coating liquid 6. A mass molar concentration of hydrogen peroxide in the obtained coating liquid 1 was 44 mol/kg.

In a case where the coating liquid 6 was evaluated according to <Evaluation method of storage stability> described above, it was confirmed that the coating liquid was transparent at three points in time of immediately after the production, after 24 hours after the production, and after 30 days after the production, and had excellent storage stability.

### Comparative Example 1

### [Step A]

The same device as in Example 1 above was used.

### (Step A1)

From the raw material inlet of the device having the above-described configuration, 413.75 g of pure water and 364.77 g of hydrogen peroxide water (manufactured by FUJIFILM Wako Pure Chemical Corporation, concentration: 30% by mass) were charged, and 27.76 g of niobium oxide hydrate (Nb₂O₅·nH₂O, manufactured by Mitsuwa Chemical Co., Ltd.; content of Nb₂O₅ was 79%) was further added thereto. After the addition of the niobium oxide hydrate, the temperature was adjusted to 23° C. while sufficiently stirring. In this manner, a slurry 11 was obtained.

56.26 g of aqueous ammonia (manufactured by FUJIFILM Wako Pure Chemical Corporation, concentration: 28% by mass) was added to the obtained slurry 11 at 23° C., and the mixture was sufficiently stirred.

The temperature of the slurry 11 was 73° C. due to the heat generated during the reaction.

7.94 g of lithium hydroxide monohydrate (manufactured by FUJIFILM Wako Pure Chemical Corporation) was added to the slurry 11 in which the temperature was raised to 39° C., and the mixture was sufficiently stirred to obtain a coating liquid (solution) 11 having a liquid temperature of 39° C. In the coating liquid 11, a molar ratio (Li/Nb) of Li to Nb was 1.1. A mass molar concentration of Nb in the obtained coating liquid 1 was 0.21 mol/kg, and a mass molar concentration of hydrogen peroxide was 50 mol/kg.

In a case where the coating liquid 11 was evaluated according to <Evaluation method of storage stability> described above, it was confirmed that, at three points in time of immediately after the production, after 24 hours after the production, and after 30 days after the production, and had excellent storage stability, scattering of the irradiated laser light was confirmed and the contour of the transmitted laser light could not be confirmed, and a white precipitate was generated in the three points in time. Therefore, it was confirmed that the coating liquid 11 had poor storage stability.

### Comparative Example 2

### [Step A]

The same device as in Example 1 above was used.

### (Step A1)

From the raw material inlet of the device having the above-described configuration, 413.81 g of pure water and 364.76 g of hydrogen peroxide water (manufactured by FUJIFILM Wako Pure Chemical Corporation, concentration: 30% by mass) were charged, and 27.75 g of niobium oxide hydrate (Nb₂O₅·nH₂O, manufactured by Mitsuwa Chemical Co., Ltd.; content of Nb₂O₅ was 79%) was further added thereto. After the addition of the niobium oxide hydrate, the temperature was adjusted to 30° C. while sufficiently stirring. In this manner, a slurry 12 was obtained.

55.26 g of aqueous ammonia (manufactured by FUJIFILM Wako Pure Chemical Corporation, concentration: 28% by mass) was added to the obtained slurry 12 at 30° C., and the mixture was sufficiently stirred.

Thereafter, the slurry 12 was heated to 55° C. at an average heating rate of 2.3° C./min. 6.90 g of lithium hydroxide monohydrate (manufactured by FUJIFILM Wako Pure Chemical Corporation) was added to the slurry 12 having a temperature of 55° C., the temperature was raised to 76° C. while sufficiently stirring, and a solution L-12 having a liquid temperature of 76° C. was obtained.

### (Step A2)

The liquid temperature of the solution L-12 was lowered from 76° C. to 40° C. at an average cooling rate of 0.5° C./min, thereby obtaining a coating liquid 12. A mass molar concentration of hydrogen peroxide in the obtained coating liquid 12 was 50 mol/kg.

In a case where the coating liquid 12 was evaluated according to <Evaluation method of storage stability> described above, the coating liquid 12 was transparent immediately after the production, but at two points in time of after 24 hours and after 30 days from the production, the irradiated laser light was scattered in the coating liquid 12 and the contour of the transmitted laser light was not confirmed, and thus it was determined that the coating liquid 12 was white colloidal. Therefore, it was confirmed that the coating liquid 12 had poor storage stability.

### Comparative Example 3

### [Step A]

The same device as in Example 1 above was used.

### (Step A1)

From the raw material inlet of the device having the above-described configuration, 413.80 g of pure water and 364.90 g of hydrogen peroxide water (manufactured by FUJIFILM Wako Pure Chemical Corporation, concentration: 30% by mass) were charged, and 27.77 g of niobium oxide hydrate (Nb₂O₅·nH₂O, manufactured by Mitsuwa Chemical Co., Ltd.; content of Nb₂O₅ was 79%) was further added thereto. After the addition of the niobium oxide hydrate, the temperature was adjusted to 20° C. In this manner, a slurry 13 was obtained.

55.26 g of aqueous ammonia (manufactured by FUJIFILM Wako Pure Chemical Corporation, concentration: 28% by mass) was added to the obtained slurry 13 at 20° C., and the mixture was sufficiently stirred.

Thereafter, the slurry 13 was heated to 61° C. at an average heating rate of 2.6° C./min. 7.95 g of lithium hydroxide monohydrate (manufactured by FUJIFILM Wako Pure Chemical Corporation) was added to the slurry 13 having a temperature of 61° C., the temperature was raised to 77° C. while sufficiently stirring, and a solution L-13 having a liquid temperature of 77° C. was obtained.

### (Step A2)

The liquid temperature of the solution L-13 was lowered from 77° C. to 40° C. at an average cooling rate of 0.9° C./min, thereby obtaining a coating liquid 13. A mass molar concentration of hydrogen peroxide in the obtained coating liquid 1 was 50 mol/kg.

In a case where the coating liquid 13 was evaluated according to <Evaluation method of storage stability> described above, the coating liquid 13 was transparent immediately after the production, but at two points in time of after 24 hours and after 30 days from the production, scattering of the irradiated laser light was confirmed and the outline of the transmitted laser light could not be confirmed, and thus it was determined that a white colloid had formed. Therefore, it was confirmed that the coating liquid 13 had poor storage stability.

From Examples 1 to 6, it was found that the coating liquids produced by the step A of the present invention maintained a transparent state immediately after the production, after 24 hours from the production, and after 30 days from the production, and had excellent storage stability.

In the niobium peroxo complexes of Examples 1 to 6, the effect of the present invention was specifically confirmed. The intermediate generated in the synthesis process of the peroxo complex itself had an unstable property, and in a case of the peroxo complex, the same intermediate could be generated even in a case where an element other than Nb was used as the element α. From the results of Examples 1 to 6, it could be speculated that a coating liquid having excellent storage stability could be obtained even in a case where the element α other than Nb was used, as in the case of Nb.

In Comparative Example 1, since the liquid temperature of the solution after the step A1 was lower than 40° C., the reaction was not accelerated, and a large amount of unreacted components remained, and thus it is considered that a white precipitate was generated immediately after the production.

In Comparative Example 2, since the ratio (Li/α) was small, the intermediate was changed to an oxide of Nb, which was a precipitate, before the intermediate reacted with the lithium compound, and thus it is considered that the intermediate was colloidalized after 24 hours from the production.

In Comparative Example 3, since the average cooling rate in the step A2 was too fast, it is considered that the peroxo complex structure could not be maintained, and the white colloid was formed after 24 hours from the production.

### <Physical Properties of Aqueous Solution>

The coating liquids 1 to 6 produced by the above-described method are described in Table 1 as Examples 1 to 6.

The coating liquids 11 to 13 produced by the above-described method are described in Table 1 as Comparative Examples 1 to 3.

Physical properties of the aqueous solution are described below.

TABLE 1

| | | NO³⁻ | | | | |
|---|---|---|---|---|---|---|
| | NH⁴⁺/α | concentration | NO³⁻/α | α concentration | pH | Li/α |
| | [mol/mol] | [×10⁻³ mol/kg] | mol/mol | mol/kg | [—] | [mol/mol] |
| Example 1 | 4.1 | 2.8 | 0.013 | 0.22 | 11.2 | 1.1 |
| Example 2 | 4.1 | 2.8 | 0.013 | 0.22 | 11.2 | 1.1 |
| Example 3 | 3.5 | 2.6 | 0.012 | 0.21 | 11.0 | 1.1 |
| Example 4 | 3.9 | 2.6 | 0.012 | 0.22 | 11.2 | 1.2 |
| Example 5 | 3.5 | 2.6 | 0.012 | 0.21 | 11.1 | 1.2 |
| Example 6 | 3.3 | 1.8 | 0.013 | 0.14 | 11.0 | 1.1 |
| Comparative | 3.8 | 4.0 | 0.019 | 0.21 | 11.2 | 1.1 |
| Example 1 | | | | | | |
| Comparative | 4.5 | 3.1 | 0.018 | 0.17 | 11.0 | 1.0 |
| Example 2 | | | | | | |
| Comparative | 4.6 | 3.1 | 0.017 | 0.18 | 11.0 | 1.1 |
| Example 3 | | | | | | |

From the results shown in Table 1 and the results of Examples 1 to 6 and Comparative Examples 1 to 3, it was found that the aqueous solution satisfying the formulation of the present invention had excellent storage stability in a case of being used as a coating liquid.

### Example 7

### [Step of Producing Metal Composite Particles]

A metal composite hydroxide containing Ni and Mn was obtained by a continuous coprecipitation method described in JP-A-2002-201028.

The lithium hydroxide was weighed at a proportion at which the amount (molar ratio) of Li with respect to the total amount 1 of Ni and Mn contained in the metal composite hydroxide was set to 1.15. The metal composite hydroxide and lithium hydroxide were mixed and sintered at 650° C. for 5 hours in an oxygen atmosphere, and then sintered at 1,000° C. for 5 hours to obtain LiMO. A center particle diameter of the LiMO, measured by a laser diffraction type particle size distribution analyzer (MT3300EXII manufactured by MicrotracBEL Corp.), was 5.4 μm, and a BET specific surface area of the LiMO, measured by a nitrogen adsorption type specific surface area and pore distribution measurement device (BELSORP-mini manufactured by MicrotracBEL Corp.), was 0.49 m²/g.

### (Preparation of Coating Liquid)

After adjustment, 310 g of the coating liquid 1 stored for 35 days in an atmosphere controlled between 20° C. and 30° C. was taken.

### [Step B]

### (Coating Step)

A roll-to-roll flow coating device (manufactured by Powrex corp., MP-01) was used in the coating step. 500 g of the LiMO was subjected to a pre-treatment of drying at 120° C. for 10 hours in a vacuum atmosphere.

Thereafter, the coating liquid 1 was sprayed onto the metal composite particles under the following conditions.
Carrier gas: carbon dioxide-free dried air (nitrogen content: 78%)
Air supply volume: 0.23 m³/min
Air temperature: 200° C.
Spray type: two-fluid nozzle (model: MPXII-LP)
Air flow rate of two-fluid nozzle: 30 NL/min
Air pressure of two-fluid nozzle: 0.07 MPa
Liquid flow rate of two-fluid nozzle: 4.5 g/min
Coating liquid injection amount: 307.1 g
Rotor rotation speed: 400 rpm

After the spraying, the two-fluid nozzle was stopped, and the coating liquid was dried for 10 minutes while maintaining the air supply temperature, the air supply rate, and the rotor rotation speed.

### (Heat Treatment Step)

After the above-described coating step, a heat treatment was performed at 300° C. for 5 hours in an oxygen atmosphere to obtain CAM7.

### [Evaluation of CAM7]

As a result of XPS analysis of CAM7 and the LiMO, at least part of the LiMO was coated with CAM7, the coating material was a lithium composite oxide containing Li and Nb, and an Nb coating rate of CAM7 was 90% or more.

The XPS analysis was carried out under the following conditions.
Measurement method: X-ray photoelectron spectroscopy (XPS)
X-ray source: AlKα ray (1486.6 eV)
X-ray spot diameter: 100 μm
Neutralization conditions: neutralization electron gun (acceleration voltage is adjusted depending on the element; current: 100 μA)

From the obtained narrow scan spectrum, the Nb coating rate was calculated as follows.
Li photoelectron intensity: integrated value of waveform of Li1s
O electron intensity: integrated value of waveform of Ols
Nb photoelectron intensity: integrated value of waveform of Nb3d
Ni photoelectron intensity: integrated value of waveform of Ni2p3/2
Mn photoelectron intensity: integrated value of waveform of Mn2pl/2

$$Nb coating rate = ( Nb photoelectron intensity ) / ( Nb photoelectron intensity + Ni photoelectron intensity + Mn photoelectron intensity ) \times 100$$

It was identified that the coating material was a lithium composite oxide because (Li light intensity of CAM7)/(Li light intensity of LiMO) was larger than the coating rate of Nb and (O light intensity of CAM7)/(O light intensity of LiMO) was larger than the coating rate of Nb.

In this manner, it was found that, by coating the metal composite particles with the coating liquid 1 having excellent storage stability, the coating amount on the CAM surface did not decrease even in the coating liquid after 30 days or more after the adjustment, and the coated CAM could be stably produced.

### REFERENCE SIGNS LIST

1 Device
2 Reaction tank
3 Temperature adjusting unit
4 Temperature control part
5 Thermometer
6 Stirring blade
7 Inlet
8 Gas discharge outlet

1. An aqueous solution comprising:
Li;
a peroxo complex of an element α;
an ammonium ion; and
a nitrate ion,
wherein the element α is one or more elements selected from the group consisting of Nb, Ti, Ta, Zr, W, Mo, and V, and
in the aqueous solution, a ratio (NH₄⁺/α) of a mass molar concentration of the ammonium ion to a mass molar concentration of the element α is less than 4.5, and a mass molar concentration of the nitrate ion (NO₃⁻) is less than 4.0×10⁻³ mol/kg.

2. The aqueous solution according to claim 1,
wherein a ratio (NO₃⁻/α) of the mass molar concentration of the nitrate ion to the mass molar concentration of the element α in the aqueous solution is less than 0.017.

3. The aqueous solution according to claim 1,
wherein a ratio (Li/α) of a mass molar concentration of Li to the mass molar concentration of the element α in the aqueous solution is more than 1.0.

4. The aqueous solution according to claim 1,
wherein the mass molar concentration of the element α is 0.10 mol/kg or more.

5. The aqueous solution according to claim 1,
wherein a pH of the aqueous solution is 11.0 or more, and
the element α is Nb.

6. A method for producing a cathode active material for lithium secondary batteries, that contains metal composite particles and a coating material with which at least part of the metal composite particles is coated, the method comprising:
a step X of bringing the aqueous solution according to claim 1 into contact with the metal composite particles to coat at least part of the metal composite particles with the coating material.

7. The method for producing a cathode active material for lithium secondary batteries according to claim 6,
wherein the metal composite particles are a lithium metal composite oxide.

8. The method for producing a cathode active material for lithium secondary batteries according to claim 6,
wherein the step X includes bringing the aqueous solution into contact with the metal composite particles by spraying the aqueous solution onto the metal composite particles, drying the aqueous solution adhered to a surface of the metal composite particles, and subjecting the metal composite particles to a heat treatment.

9. A method for producing a cathode active material for lithium secondary batteries, that uses metal composite particles and a coating material with which at least part of the metal composite particles is coated, the method comprising:
a step A of preparing a coating liquid,
wherein the step A includes a step A1 of mixing a compound containing an element α, a solution containing hydrogen peroxide, a solution containing ammonia, and a lithium compound to prepare a solution L having a liquid temperature of higher than 40° C., and a step A2 of cooling the solution L to 40° C. or lower to obtain the coating liquid,
the element α is one or more elements selected from the group consisting of Nb, Ti, Ta, Zr, W, Mo, and V,
the coating liquid contains a peroxo complex of the element α, and Li,
a ratio (Li/α) of a mass molar concentration of Li to a mass molar concentration of the element α in the coating liquid is more than 1.0, and
an average cooling rate of the solution L from the liquid temperature to 40° C. in the step A2 is less than 0.9° C./min.

10. The method for producing a cathode active material for lithium secondary batteries according to claim 9,
wherein the mass molar concentration of the element α in the coating liquid is 0.10 mol/kg or more.

11. The method for producing a cathode active material for lithium secondary batteries according to claim 9,
wherein the step A1 includes an operation of adding the lithium compound to a slurry containing the compound containing the element α, the solution containing hydrogen peroxide, and the solution containing ammonia, the slurry having a temperature of 35° C. or higher.

12. The method for producing a cathode active material for lithium secondary batteries according to claim 9,
wherein the step A1 includes an operation of heating a slurry containing the compound containing the element α, the solution containing hydrogen peroxide, and the solution containing ammonia at an average heating rate of 0.9° C./min or more and 10° C./min or less, and adding the lithium compound to the slurry having a temperature of 35° C. or higher.

13. The method for producing a cathode active material for lithium secondary batteries according to claim 9,
wherein the element α is Nb.

14. The method for producing a cathode active material for lithium secondary batteries according to claim 9,
wherein the compound containing the element α is a compound containing niobium oxide, and
the lithium compound is a compound including lithium hydroxide or lithium hydroxide hydrate.

15. The method for producing a cathode active material for lithium secondary batteries according to claim 9, further comprising, after the step A:
a step B of coating at least part of the metal composite particles with the coating liquid,
wherein the step B includes spraying the coating liquid onto the metal composite particles, drying the coating liquid adhered to a surface of the metal composite particles, and subjecting the metal composite particles to a heat treatment.
